(19) United States
(12) Patent Application Publication
(10) Pub. No.: US 2006/0016108 A1
(43) Pub. Date: Jan. 26, 2006

(54) Beverage utensil with indicia

(76) Inventor: Bruce D. Watts, Greens Fork, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/896,695

(22) Filed: Jul. 22, 2004

(51) Int. Cl. G09F 3/10

(52) U.S. Cl. 40/299.01

(57) ABSTRACT

A beverage utensil including an indicia is described. The beverage utensil is placed into a beverage. The beverage utensil may be, for example, a drinking straw or a stirring stick. The indicia may contain a variety of messages including the type of beverage, the alcohol content of the drink, or an advertisement, among a variety of other messages.

### TECHNICAL FIELD OF THE INVENTION

The present invention generally relates to drinking utensils and, more specifically, to beverage utensils with indicia.

### BACKGROUND

The restaurant and food industry has grown exponentially over the last few years. The art of cooking is becoming more and more a lost art by the American public and more and more people are eating out. Commonly when attending a restaurant, people order beverages along with their main dishes. Many people prefer to use drinking straws while enjoying their beverages. In addition, many beverages are mixed with a stirrer stick after they are prepared.

When waitresses are loading beverages onto their server tray, many times it is difficult to tell the difference between the beverages. For example, regular cola and cherry flavored cola many times look identical, but have a completely different taste. Many times beverages have alcohol added to them and it is impossible to distinguish between a beverage that contains alcohol and one that is non-alcoholic. In addition, the increased number of people dining out has escalated the competition in the restaurant business. Therefore, restaurants must find new and unique ways to make themselves stand out from the competition.

Thus, there is a need for further contribution in this area of the technology.

### SUMMARY

In one form, a method for identifying beverages is described. The method includes providing a beverage utensil including an indicia, wherein the indicia indicates a type of beverage and placing the beverage utensil into the type of beverage.

In another form, a method of communicating using a beverage is described. The method includes placing a beverage utensil including an indicia in a beverage, the indicia describing a message.

In yet another form, a beverage identifier is described. The beverage identifier includes a beverage utensil including an indicia, wherein the beverage utensil is constructed and arranged to be placed into a beverage.

### BRIEF DESCRIPTION OF THE DRAWINGS

FIG. 1 is a perspective view of the drinking straw bearing an indicia according to one embodiment of the present invention.

FIG. 2 is perspective view of a beverage tray including a plurality of beverages with alternate types of drinking straws with different indicias.

### DESCRIPTION OF THE SELECTED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations, modifications, and further applications of the principles of the present invention as illustrated are contemplated as would normally occur to one skilled in the art to which the invention relates.

The present invention relates to placing an indicia on different types of beverage utensils. In one embodiment, the beverage utensils are drinking straws. The drinking straws may be extendable or flexible. In yet another embodiment, the beverage utensils are stirring sticks. One embodiment has the indicia describing the type of beverage that is being served. Other embodiments have an indicia describing an advertisement or other messages.

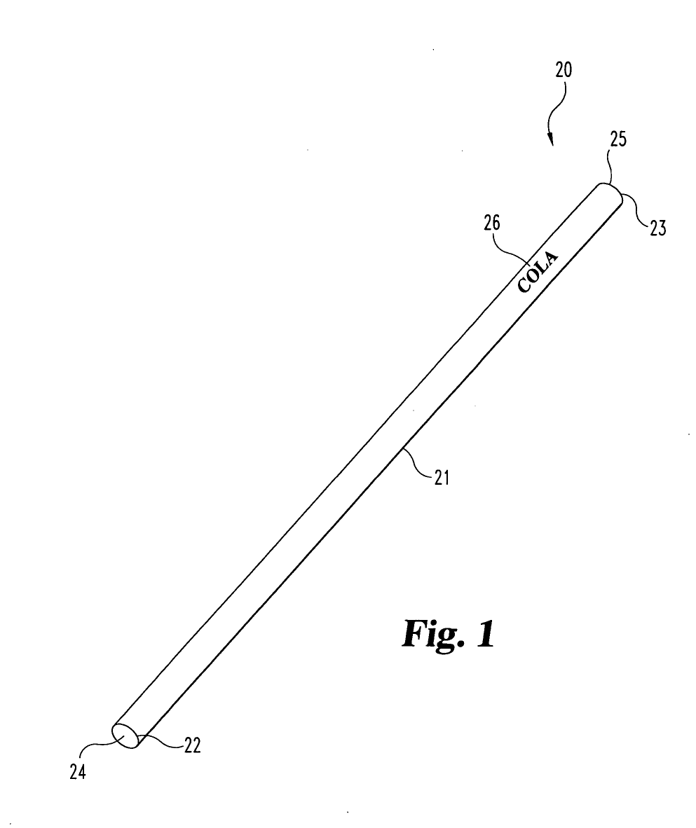

Referring now to FIG. 1, a beverage utensil 20 is illustrated. The beverage utensil 20 includes a straw body 21, a first end 22 and a second end 23. The straw body 21 defines a channel that separates the fluid on the inside of beverage utensil 20 from the remaining fluid in the beverage. The first end 22 is the end that will be placed into a beverage. The first end 22 defines a first opening 24 that will draw the fluid through the beverage utensil 20 when a pressure drop is created by the user using the beverage utensil 20. The second end 23 is the end that the user's mouth will be placed upon. The second end 23 defines a second opening 25 through which the fluid will pass into the user's mouth when the user creates a pressure drop in the beverage utensil 20. The indicia 26 is illustrated in the embodiment of FIG. 1 to be the word “Cola.” In alternative embodiments, differing beverage identifiers may be used. Some examples, among others, include the words “Diet,” “Alcoholic,” and “Iced Tea.” In the illustrated embodiment, the beverage utensil 20 is illustrated as a drinking straw. It is contemplated that in an alternate embodiment, the beverage utensil 20 is a stirring stick. In addition, a variety of alternate beverage utensils readily apparent to one skilled in the art may be utilized in alternative embodiments.

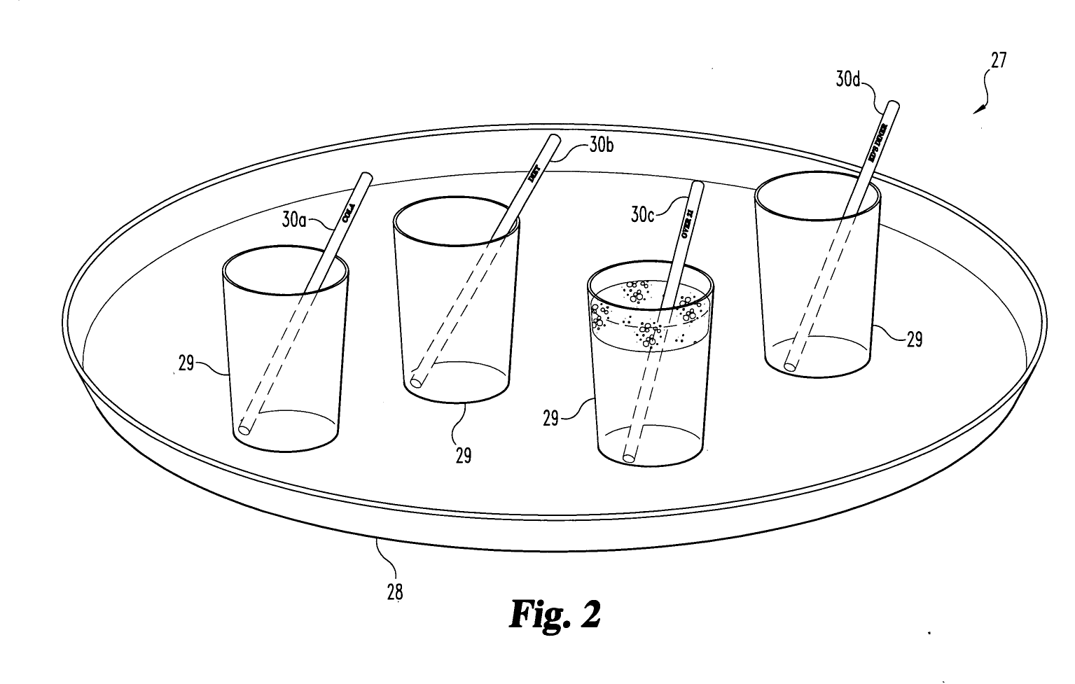

Referring now to FIG. 2, a beverage group is illustrated and indicated generally at 26. The beverage group 26 includes a serving tray 28 for holding a group of beverages to be served to customers, beverages 29, and a plurality of beverage utensils 30a, 30b, 30c and 30d. Beverage utensil 30a includes indicia that identifies it as “Cola.” Beverage utensil 30b includes the indicia “Diet.” Beverage utensil 30c includes the indicia “Over 21.” Beverage utensil 30d includes the indicia “Ed's Diner.”

The inclusion of all of these different indicias for the different beverages provides a variety of different solutions to both the server and the customer. In addition, the proprietor also may take advantage of indicias to be able to stand out from the competition. For example, both the server and the customer are able to better identify their beverages using the beverage utensils 30a and 30b. Many times it is confusing and difficult to distinguish between a Cola and Diet Cola soft drink. Moreover, for criminal and liability reasons, having a beverage utensil that identifies alcohol content as shown in beverage utensil 30c would benefit the proprietor. Finally, the proprietor may be able to advertise or stand out from the competition with the use of the indicia described in beverage utensil 30d. While a variety of indicia has been illustrated in the embodiments of FIG. 2, one skilled in the art would readily recognize that an infinite number of indicia may be used.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A method for identifying beverages, comprising:
providing a first beverage utensil including a first indicia, wherein said first indicia indicates a first type of beverage;
providing a second beverage utensil including a second indicia, wherein said second indicia indicates a second type of beverage;
providing a first beverage of said first type of beverage;
providing a second beverage of said second type of beverage;
matching said first beverage utensil to said first beverage of said first type of beverage;
matching said second beverage utensil to said second beverage of said second type of beverage;
placing said first beverage utensil into said first beverage; and
placing said second beverage utensil into said second beverage.

2. The method of claim 1, wherein said beverage utensil is a drinking straw.

3. The method of claim 1, wherein said beverage utensil is a stirring stick.

4. (canceled)

5. (canceled)

6. The method of claim 1, wherein said beverage utensil is plastic.

7-18. (canceled)
